(19) United States
(12) Patent Application Publication
(10) Pub. No.: US 2012/0047798 A1
(43) Pub. Date: Mar. 1, 2012

(54) Herbicide Delivery Apparatus and Method

(76) Inventor: Edward A. Komorek, JR., Caseyville, IL (US)

(21) Appl. No.: 12/870,847

(22) Filed: Aug. 30, 2010

(51) Int. Cl. A01M 21/00

(52) U.S. Cl. 47/1.43

(57) ABSTRACT

An herbicide delivery apparatus which administers an herbicide to a plant by receiving a plant member such as a stem or vine into an herbicide-filled cavity via a primary reservoir cap. The herbicide delivery apparatus may also administer an herbicide by removing a tapered reservoir cap and inserting a tapered reservoir into a cavity of a plant member such as a stump or branch. Once inserted, the herbicide may flow out of the herbicide-filled cavity and into the plant cavity.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

Herbicides can be an effective tool for eradicating or exterminating unwanted plants. Herbicides are typically administered to plants using an exterior approach or an interior approach. Exterior approaches typically involve an herbicide being sprayed or otherwise applied to the exterior of the plant, while interior approaches often attempt to directly expose the interior of the plant to an herbicide by, for example, an injection-like procedure. While certain exterior and interior approaches have been practiced for some time, all of the currently available approaches have significant limitations.

For instance, exterior approaches often run the risk of spraying or otherwise exposing the wrong plants to herbicides due to their proximity to the targeted plants. This is in addition to other risks such as accidentally spilling herbicides during the preparation or application process, which is not only wasteful, but can cause long-term damage to the affected soil. While many interior approaches suffer from similar shortcomings, they are also frequently limited in their application to certain types of plants or conditions, and can require complex, fragile, and sometimes costly equipment as well.

### SUMMARY OF THE INVENTION

The present invention has been developed in response to the present state of the art, and in particular, in response to problems and needs that have not yet been solved by currently available solutions.

In one embodiment of the present invention, an apparatus includes a primary reservoir that comprises a primary reservoir cavity and an herbicide reception interface. The herbicide reception interface may be formed or otherwise configured to enable an herbicide to be easily introduced into the primary reservoir cavity for storage. The apparatus may also include a primary reservoir cap that can be coupled with the primary reservoir to prevent or deter the herbicide from exiting the primary reservoir cavity via the herbicide reception interface.

In some embodiments, the primary reservoir may be connected to a tapered reservoir that includes a tapered reservoir cavity and an herbicide delivery interface. The herbicide delivery interface may be formed or configured to enable the herbicide inside the primary and tapered reservoirs to exit the apparatus in a controlled manner. However, the apparatus may also include a tapered reservoir cap that can be coupled with the tapered reservoir to prevent the herbicide from exiting the apparatus via the herbicide delivery interface.

In certain embodiments, the primary reservoir cap may include a plant reception interface that enables a plant member to be inserted into the primary reservoir via the primary reservoir cap. In some embodiments, the apparatus may also include a primary reservoir coupler that enhances the coupling between the primary reservoir cap and the primary reservoir. Similarly, the apparatus may also include a tapered reservoir coupler that enhances the coupling between the tapered reservoir cap and the tapered reservoir.

In certain embodiments, the apparatus may also include a stabilization portion that connects the primary reservoir and the tapered reservoir. The stabilization portion may be formed or configured to help stabilize the apparatus once the apparatus, or a portion thereof, is inserted into a plant cavity. In some embodiments, the primary reservoir and the tapered reservoir are formed from a pliable and transparent polymer.

In another embodiment of the present invention, a method may include removing a primary reservoir cap that is coupled with a primary reservoir. The primary reservoir may include a primary reservoir cavity and an herbicide reception interface. In addition, the primary reservoir may be connected to a tapered reservoir that includes a tapered reservoir cavity and an herbicide delivery interface. The method may also include introducing an herbicide into the primary reservoir cavity of the primary reservoir via the herbicide reception interface. The method may further include coupling the primary reservoir cap with the primary reservoir and inserting a plant member into the primary reservoir cavity via the primary reservoir cap.

In certain embodiments, inserting the plant member via the primary reservoir cap may include inserting the plant member via a plant reception interface of the primary reservoir cap. Also, coupling the primary reservoir cap with the primary reservoir may include engaging a primary reservoir coupler of the primary reservoir with the primary reservoir cap. In certain embodiments, the method may also include coupling a tapered reservoir cap with the herbicide delivery interface via a tapered reservoir coupler of the tapered reservoir.

In another embodiment of the present invention, a method may include removing a primary reservoir cap that is coupled with a primary reservoir. The primary reservoir may include an herbicide reception interface and a primary reservoir cavity. In addition, the primary reservoir may be connected to a tapered reservoir that includes a tapered reservoir cavity and an herbicide delivery interface. The method may also include removing a tapered reservoir cap that is coupled with the tapered reservoir.

In some embodiments, the method may also include inserting the tapered reservoir into a plant cavity and introducing an herbicide into the primary reservoir cavity via the herbicide delivery interface of the primary reservoir. The method may also include enabling the herbicide to exit the apparatus via the herbicide delivery interface and into the plant cavity. In certain embodiments, the primary reservoir cap may be coupled with the primary reservoir to prevent the herbicide from exiting the apparatus via the herbicide reception interface. The method may also include engaging a stabilization portion that connects the primary reservoir and the tapered reservoir with a surface of a plant to further stabilize the apparatus within the plant cavity.

### BRIEF DESCRIPTION OF THE DRAWINGS

A more particular description of the present invention will now be rendered by reference to the appended Figures. These Figures depict only some embodiments of the invention and are not limiting of its scope. Regarding the Figures:

FIG. 1 is a perspective view of an herbicide delivery apparatus in accordance with one or more embodiments of the present invention;

FIG. 2A is a perspective view of another herbicide delivery apparatus in accordance with one or more embodiments of the present invention;

FIG. 2B is a perspective view of a primary reservoir cap in accordance with one or more embodiments of the present invention;

FIG. 2C is a top-down perspective view of a primary reservoir cap in accordance with one or more embodiments of the present invention;

FIG. 2D is a perspective view of a tapered reservoir cap in accordance with one or more embodiments of the present invention;

FIG. 3 is a perspective view of another herbicide delivery apparatus in accordance with one or more embodiments of the present invention;

FIGS. 4A-4F are perspective views of an herbicide delivery apparatus at different stages of an herbicide delivery method in accordance with one or more embodiments of the present invention; and

FIGS. 5A-5E are perspective views of an herbicide delivery apparatus at different stages of an herbicide delivery method in accordance with one or more embodiments of the present invention.

### DETAILED DESCRIPTION OF PREFERRED EMBODIMENTS

The present invention is directed to controlling plant growth. More specifically, the present invention is directed to herbicide delivery apparatuses and methods.

The following description and accompanying Figures demonstrate that the present invention may be practiced or implemented in a variety of embodiments. The discussion of these embodiments amounts to a complete written description that enables those of ordinary skill in the art to make and use the invention. While several embodiments are expressly disclosed herein, it should be appreciated that the present invention is not limited to the specifically disclosed embodiments. Indeed, the structures, features, operations or functions of the described embodiments may be reorganized or reconfigured to create one or more embodiments that are not specifically discussed herein, but nevertheless fall within the scope the present invention.

Further, the use of words or phrases such as “certain embodiments,” “some embodiments,” “may,” “can,” or similar language means that a particular feature, structure, function, characteristic, or benefit described in connection with an embodiment is included in at least one embodiment of the present invention. Thus, appearances of “certain embodiments,” “some embodiments,” “may,” “can,” or similar language do not necessarily all refer to the same embodiment or group of embodiments and the described features, structures, functions, characteristics, or benefits may vary from one embodiment to another.

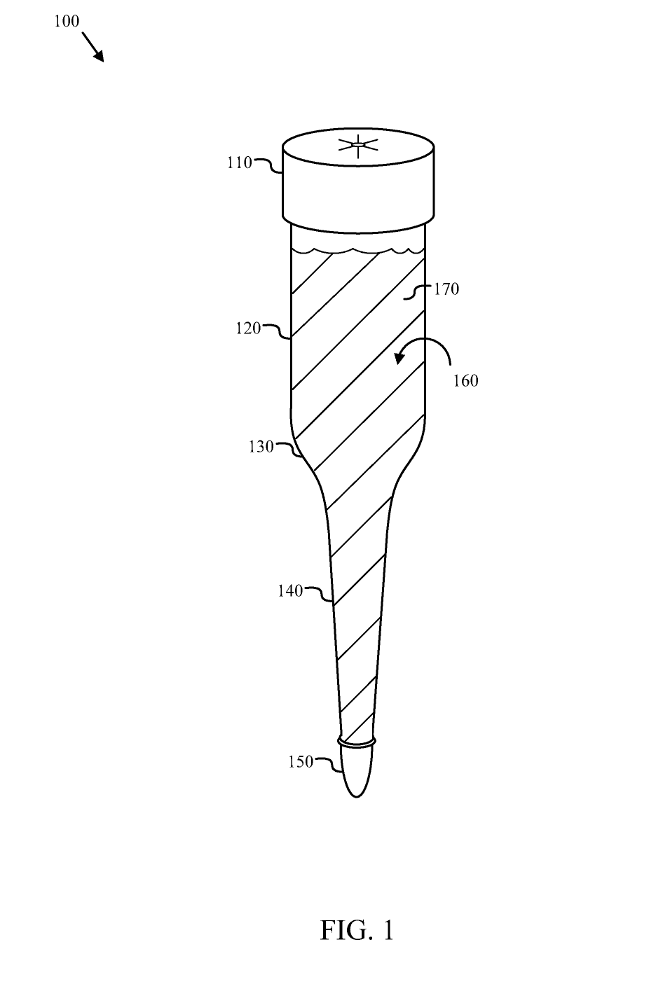

FIG. 1 is a perspective view of an herbicide delivery apparatus 100 in accordance with one or more embodiments of the present invention. The depicted apparatus 100 includes a primary reservoir cap 110, a primary reservoir 120, a stabilization portion 130, a tapered reservoir 140, and a tapered reservoir cap 150. As discussed throughout this specification, the foregoing features and components enable versatile and effective solutions to administering or delivering herbicides to unwanted plants.

For instance, the herbicide delivery apparatus 100 may administer an herbicide by receiving a relatively thin plant member such as a stem or vine (not shown) into an herbicide-filled cavity 160 via the primary reservoir cap 110. Alternatively, the herbicide delivery apparatus 100 may also administer an herbicide by removing the tapered reservoir cap 150 and inserting the tapered reservoir 140 into a cavity of a relatively thick plant member such as a stump or branch (not shown). Once inserted, the herbicide 170 may flow out of the herbicide-filled cavity 160 and into the plant cavity. Accordingly, the herbicide delivery apparatus 100 provides a versatile delivery solution that is effective in various scenarios and on plants that vary in type and size.

The features and components of the herbicide delivery apparatus 100 may comprise or be formed from a variety of different materials, including metals, rubbers, and synthetic polymers, that may vary in color, transparency, pliability, and other characteristics. For instance, the primary reservoir 120, the stabilization portion 130 and the tapered reservoir 140 may be formed from a single, continuous polymer, while the primary reservoir cap 110 and the tapered reservoir cap 150 may be formed from a flexible yet resilient rubber. In such embodiments, said single, continuous polymer may be transparent, to enable a user to readily ascertain, for example, the amount of herbicide in the apparatus 100 or the position of a plant member within the apparatus 100. Further, the polymer may be relatively thin (e.g., one-thirty-second ( 1/32) of an inch thick), making the overall apparatus 100 relatively lightweight and, in some embodiments, pliable.

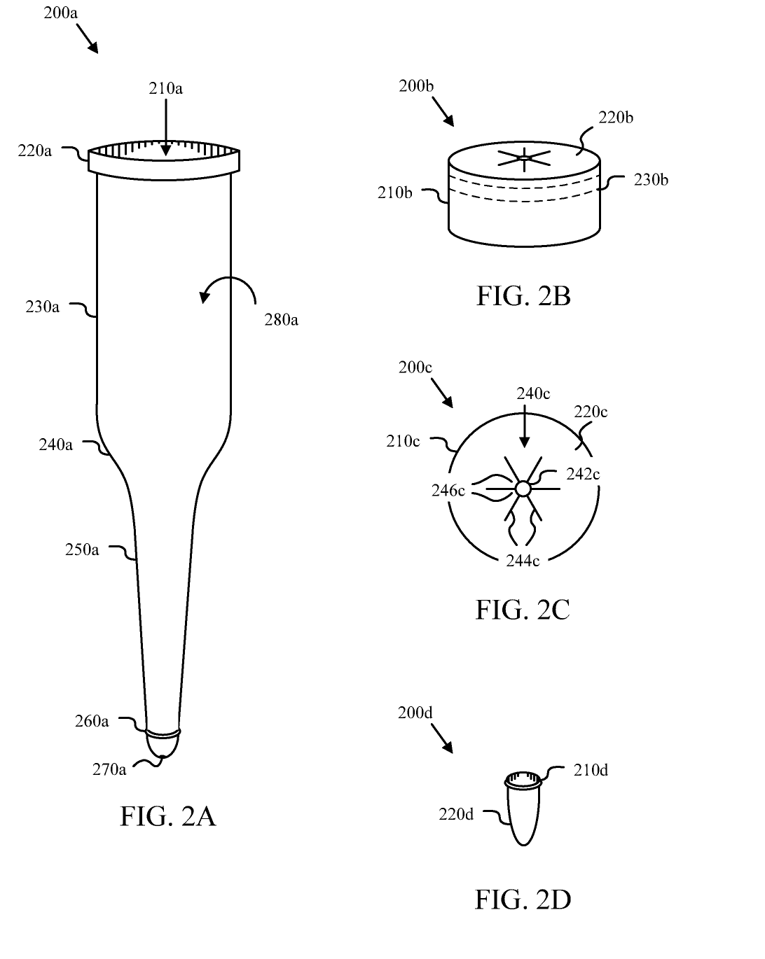

FIG. 2A is perspective view of another herbicide delivery apparatus 200a in accordance with one or more embodiments of the present invention. The depicted apparatus 200a includes a primary reservoir interface 210a, a primary reservoir coupler 220a, a primary reservoir 230a, a stabilization portion 240a, a tapered reservoir 250a, a tapered reservoir coupler 260a, and an herbicide delivery interface 270a. In some embodiments, the herbicide delivery apparatus 200a may correspond to the herbicide delivery apparatus of FIG. 1.

In certain embodiments, one or more herbicides (not shown) may be poured or otherwise introduced into a hollow cavity or enclosure 280a via the herbicide reception interface 210a. The dimensions of the cavity 280a may be defined by or complementary to the sum of a primary reservoir cavity 230a, a stabilization portion cavity 240a, and a tapered reservoir cavity 250a. In certain embodiments, these soda bottle-like dimensions enable the herbicide delivery apparatus 200a to dedicate the vast majority of the its overall volume to storing herbicides, while still enabling the distinct herbicide delivery techniques discussed above in reference to FIG. 1.

In the depicted embodiment, the herbicide reception interface 210a comprises a hole or opening that is tantamount to the maximum circumference of the herbicide delivery apparatus 200a. An herbicide reception interface of this size can simplify the process of introducing an herbicide into the herbicide delivery apparatus 200a and help avoid accidental spillages that might otherwise occur. In some embodiments, the herbicide reception interface 210a may include a beveled ridge that forms a funnel-like opening to further facilitate the insertion of herbicides into the herbicide delivery apparatus 200a.

In certain embodiments, the primary reservoir coupler 220a is configured to assist in removably securing or coupling a primary reservoir cap (see FIG. 2B) to the primary reservoir 230a. In the depicted embodiment, the primary reservoir coupler 220a comprises a ridge structure that is complementary to the circumference of the primary reservoir 230a. It should be appreciated, however, that the primary reservoir coupler 220a may be embodied by alternative structures capable of coupling a primary reservoir cap to the herbicide delivery apparatus 200a.

Words and phrases herein such as “coupled”, “coupling” and “configured to couple” are intended to convey that, for example, the objects associated with such words or phrases may be manually attached, detached, and reattached by a user, without destroying or significantly altering the structural integrity of the objects.

Similar to the primary reservoir coupler 220a discussed above, the tapered reservoir coupler 260a may be configured to removably secure or couple a tapered reservoir cap (see FIG. 2C) to the herbicide delivery apparatus 200a. The depicted coupler 260a comprises an edged structure that is complementary to the circumference of the tapered reservoir. However, the tapered reservoir coupler 260a may be embodied by a variety of alternative structures capable of coupling a tapered reservoir cap to the herbicide delivery apparatus 200a.

In certain embodiments, the tapered herbicide interface 270a may be configured to enable or otherwise permit an herbicide stored in the cavity 280a to exit the herbicide delivery apparatus 200a. As such, the tapered herbicide interface 270a may include one or more holes, slits, or other channel-like structures configured to permit an herbicide to pass therethrough. In certain embodiments, the size and dimensions of such channel-like structures 270a may be configured to prevent an herbicide from exiting the herbicide delivery apparatus 200a at an undesirably high or low rate. This not only helps ensure that the herbicide is administered to the plant at an appropriate rate, but the size and dimensions of the channel-like structures can also prevent waste and unintended contaminations that may result from herbicide overflows or spills.

FIG. 2B is a perspective view of a primary reservoir cap 200b in accordance with one or more embodiments of the present invention. The primary reservoir cap 200b includes a circumferential wall 210b, a top surface 220b and a primary cap coupler 230b. In certain embodiments, the primary reservoir cap 200b corresponds to the primary reservoir cap of FIG. 1 and can play a multi-functional role in the herbicide delivery solution disclosed herein.

As mentioned previously, the primary reservoir cap 200b may be configured to couple with the primary reservoir 230a. When attached, the circumferential wall 210b and the top surface 220b of the primary reservoir cap 200b may function as a barrier that deters contaminants from entering the primary reservoir 230a and, concurrently, deters herbicides from exiting the primary reservoir 230a.

In some embodiments, coupling the primary reservoir cap 200b with the primary reservoir 230a is facilitated by a primary reservoir cap coupler 230b, which may be positioned on the interior surface of the circumferential wall 210b. The primary reservoir cap coupler 230b may be embodied by a variety of structures or features, including protrusions, recesses, or structurally independent entities. In the depicted embodiment, the primary reservoir cap coupler 230b comprises a continuous recess around the inner circumference of the circumferential wall 210b and is sufficiently deep to receive the primary reservoir coupler 220a.

FIG. 2C is a top-down perspective view of a primary reservoir cap 200c in accordance with one or more embodiments of the present invention. Similar to the primary reservoir cap of FIG. 2B, the primary reservoir cap of FIG. 2C includes a circumferential wall 210c, a top surface 220c and a plant member interface 240c. In certain embodiments, the primary reservoir cap 200c may correspond to the primary reservoir cap of FIG. 1.

The plant member interface 240c may be configured to enable a plant member to pass through the primary reservoir cap 200c and into the primary reservoir 230a. For instance, in the depicted embodiment, the plant member interface 240c includes a hole 242c connecting several incisions 244c that collectively define six flaps 246c in the top surface 220c of the primary reservoir cap 200c. As such, the flaps 246c may be configured to yield to an incoming plant member (not shown) that then becomes exposed to the herbicide within the herbicide delivery apparatus 200a.

Further, in embodiments where the flaps 246c consist of a somewhat resilient or elastic material, such as rubber, the flaps 246c may remain biased against the plant member to prevent or deter the herbicide within the apparatus 200a from escaping. Accordingly, the primary reservoir cap 200c may permit intended objects such as branches, stems or vines to enter the apparatus 200a, while simultaneously acting as a barrier for contaminants that might enter or herbicides that might exit the apparatus 200a.

FIG. 2D is a perspective view of a tapered reservoir cap 200d in accordance with one or more embodiments of the present invention. The tapered reservoir cap 200d includes a tapered reservoir cap body 210d and a tapered reservoir cap coupler 220d. In certain embodiments, the tapered reservoir cap 200d corresponds to the tapered reservoir cap of FIG. 1.

As mentioned above, the tapered reservoir cap 200d may be configured to couple with the tapered reservoir 250a. In certain embodiments, this is facilitated by the tapered reservoir cap coupler 210d mating or otherwise engaging the tapered reservoir coupler 260a. Similar to the primary reservoir cap coupler 230, the tapered reservoir cap coupler may be embodied in several ways, including protrusions, recessions or independent structures capable of removably securing the tapered reservoir cap 200d to the tapered reservoir 250a.

Whether the tapered reservoir cap 200d is coupled to the tapered reservoir 200d can depend on what type of herbicide delivery procedure is being performed. For instance, during a delivery procedure where a plant member is inserted into the apparatus 200a via the primary reservoir cap 200b, the tapered reservoir cap 200d may remain coupled to the tapered reservoir 250a in order to prevent the herbicide from escaping via the herbicide delivery interface 275a. On the other hand, during a delivery procedure where the tapered reservoir 250a is inserted into a plant cavity, the tapered reservoir cap 200d may be removed from the tapered reservoir 250a to enable the herbicide to exit the herbicide delivery interface 270a and be absorbed or siphoned by the plant.

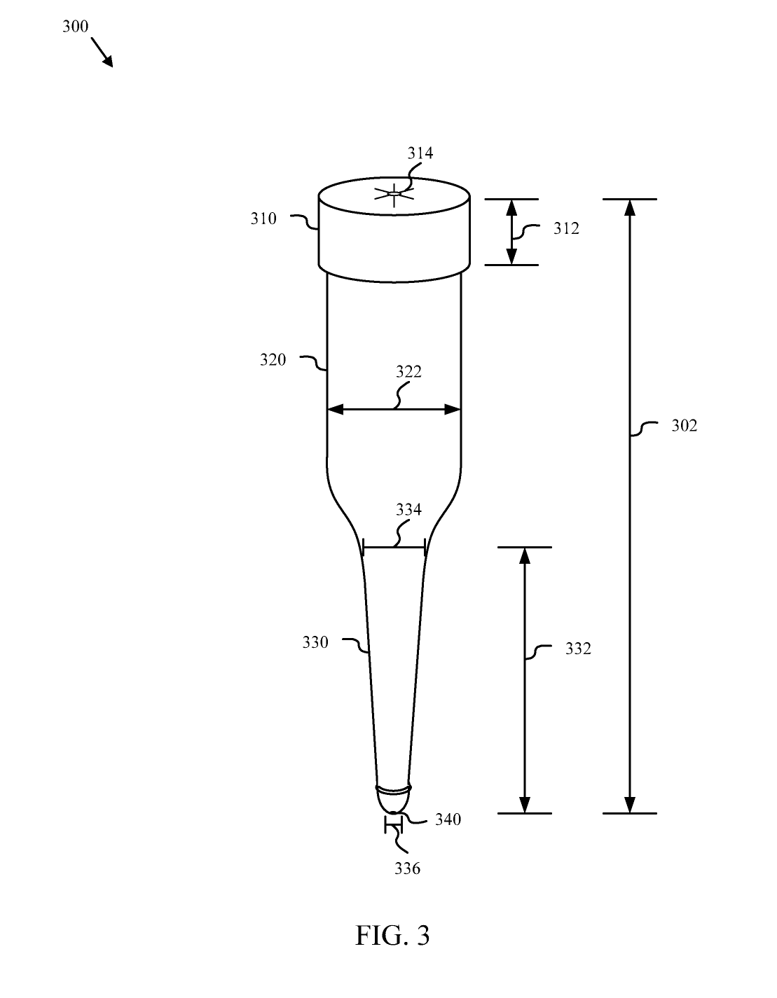

FIG. 3 is a perspective view of an herbicide delivery apparatus 300 in accordance with one or more embodiments of the present invention. The herbicide delivery apparatus 300 includes a primary reservoir cap 310, a primary reservoir 320, a tapered reservoir 330, and an herbicide delivery interface 340. In certain embodiments, the herbicide delivery apparatus 300 corresponds to the herbicide delivery apparatuses of FIGS. 1 and 2.

In some embodiments, the length 302 of the entire herbicide delivery apparatus 300 may be approximately four and one-half (4 and ½) inches, and the length 312 of the primary reservoir cap 310 may be approximately one-half (½) of an inch. As for the tapered reservoir 330, the overall length 332 may be approximately two and seven-eighths (2 and ⅞) inches, while the diameter 334 near the primary reservoir 320 may be approximately nine-thirty-seconds ( 9/32) of an inch, and the diameter of the herbicide delivery interface 340 may be approximately three-sixteenths ( 3/16) of an inch. The diameter 322 of the primary reservoir 320 may be approximately four-fifths (⅘) of an inch, and the diameter of the herbicide delivery interface 340 may be approximately one-sixteenth ( 1/16) of an inch. In certain embodiments, forming an herbicide delivery apparatus 300 with these dimensions can amount to an herbicide delivery solution that optimizes many of the functions and operations described herein.

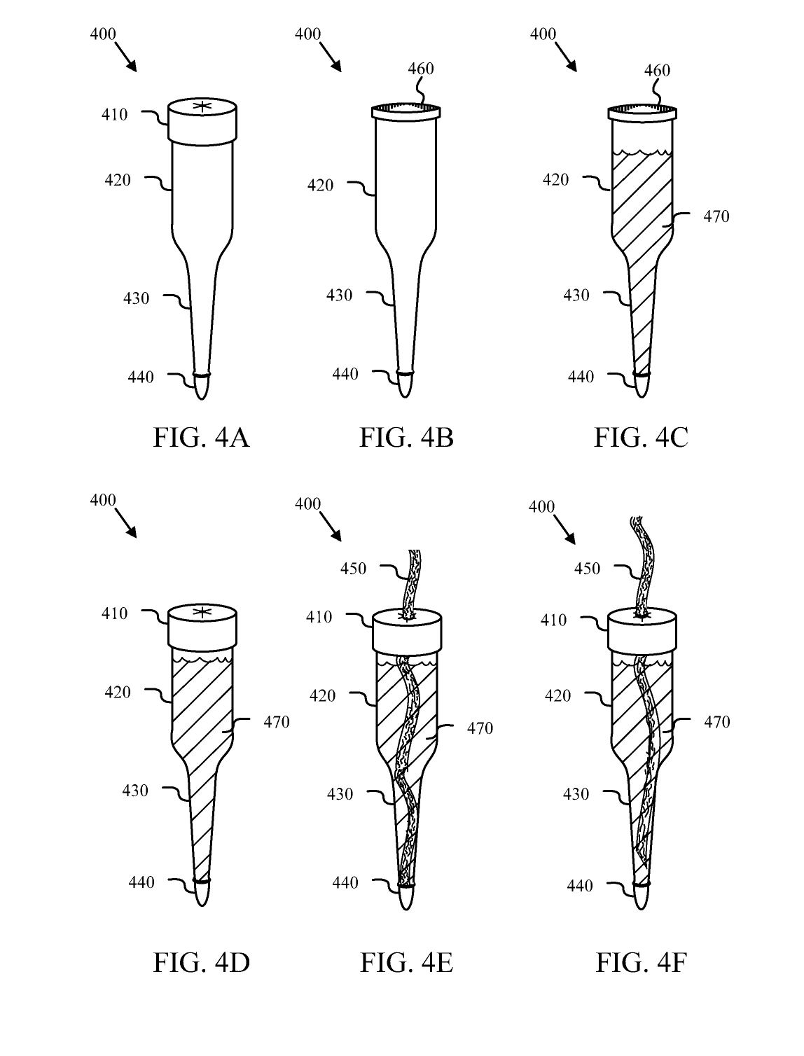

FIGS. 4A-4F are perspective views of an herbicide delivery apparatus 400 at different stages of an herbicide delivery method in accordance with one or more embodiments of the present invention. The herbicide delivery apparatus 400 includes a primary reservoir cap 410, a primary reservoir 420, a tapered reservoir 430, and a tapered reservoir cap 440. In certain embodiments, the herbicide delivery apparatus 400 may correspond to any of the herbicide delivery apparatuses of FIGS. 1-3.

The herbicide delivery method begins with an herbicide delivery apparatus 400 without any herbicide in the primary reservoir 420 or the tapered reservoir 430a (see FIG. 4A). As such, the primary reservoir cap 410 may be removed in order to gain access to the herbicide reception interface 460 (see FIG. 4B). An herbicide or herbicide mixture 470 may then be poured or otherwise introduced into the herbicide delivery apparatus 400 via the herbicide reception interface 460 (see FIG. 4C).

The primary reservoir cap 410 may then be recoupled with the primary reservoir 420 to prevent or deter the herbicide 470 from exiting the apparatus 400 (see FIG. 4D). Once the apparatus 400 has been filled with an herbicide 470 and the primary reservoir cap 410 has been replaced, a plant member 450 may be inserted into the apparatus 400 via the primary reservoir cap 410 (see FIG. 4E).

As depicted, the plant member 450 may be inserted until it has traversed the length of the apparatus 400 and arrives at or near the tapered reservoir cap 440 (again see FIG. 4E). Then, the plant member 450 may be retracted a short distance and left to rest (see FIG. 4F). In time, the plant member 450 will siphon and/or absorb the herbicide 470 into the roots of the plant, causing it to wilt and die. As such, the present invention can provide a highly effective herbicide delivery solution while minimizing the risks of unintended contaminations or spills.

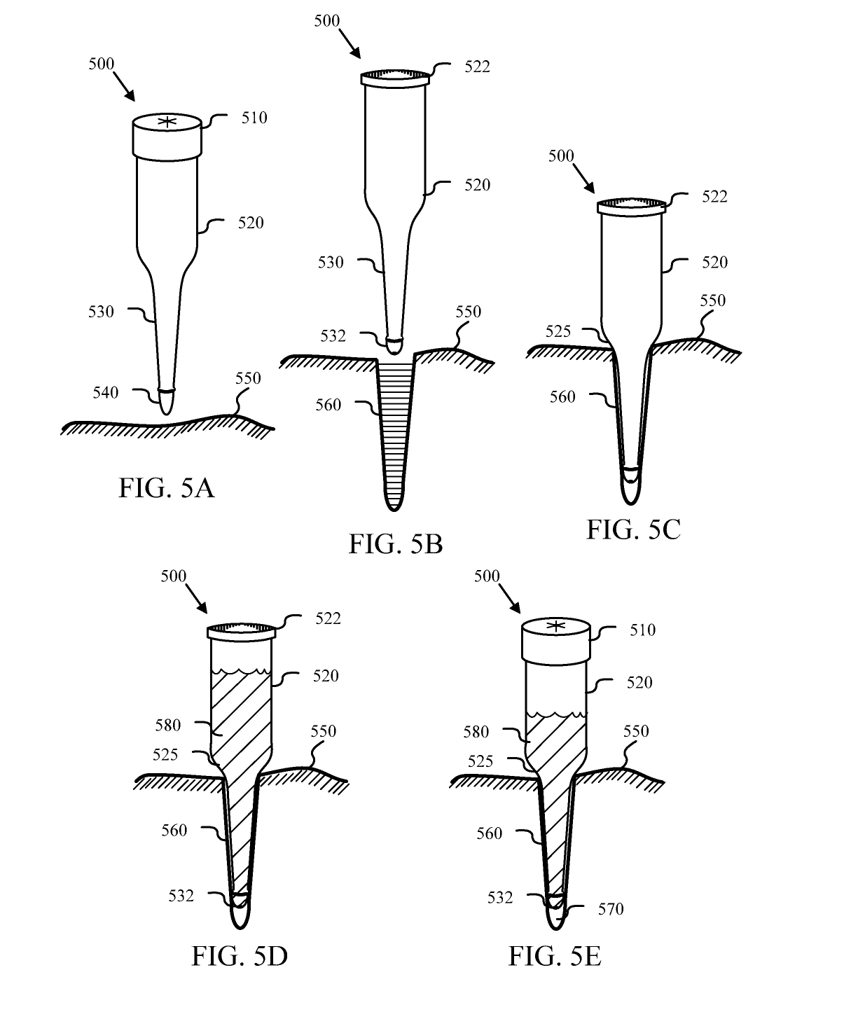

FIGS. 5A-5E are perspective views of an herbicide delivery apparatus 500 at different stages of an herbicide delivery method in accordance with one or more embodiments of the present invention. The herbicide delivery apparatus 500 includes a primary reservoir cap 510, a primary reservoir 520, a stabilization portion 525, a tapered reservoir 530, and a tapered reservoir cap 540. In certain embodiments, the herbicide delivery apparatus 500 may correspond to any of the herbicide delivery apparatuses of FIGS. 1-4.

The herbicide delivery method begins by identifying an appropriate plant surface 550 for inserting the herbicide delivery apparatus 500 (see FIG. 5A). In certain embodiments, an appropriate plant surface 550 may be a relatively large portion of the plant such as a stump or a thick branch. Then, the primary reservoir cap 510 and the tapered reservoir cap 540 may be removed and set aside (see FIG. 5B). Also, a hole or plant cavity 560 may be drilled or otherwise formed in the targeted plant surface 550 (again see FIG. 5B). The requisite size or volume of the plant cavity 560 may depend upon the size of the herbicide delivery apparatus 500 and, in particular, the volume of the tapered reservoir 530.

Once an appropriate hole has been created, the herbicide delivery apparatus 500 may be inserted into targeted plant surface 550 until the stabilization portion 525 of the herbicide delivery apparatus 500 engages the plant surface 550 (see FIG. 5C). In certain embodiments, engaging the targeted plant surface 550 in this manner can help stabilize the herbicide delivery apparatus 500 within the plant cavity 560. Also, in embodiments where the stabilization portion 525 comprises a pliable medium, such as a soft or pliable polymer, additional pressure may be applied to the herbicide delivery apparatus 500 to gently wedge the apparatus 500 into the plant cavity 560 for additional stability.

With the herbicide delivery apparatus 500 inserted in the plant cavity 560, an herbicide 580 may be introduced into the herbicide delivery apparatus 500 via the herbicide reception interface 522 (see FIG. 5D). The amount of herbicide introduced into the herbicide delivery apparatus 500 may depend upon a variety of factors such as the robustness of the targeted plant, the potency of the herbicide 580, and the stability of the herbicide delivery apparatus 500. Once the herbicide 580 has been added, the primary reservoir cap 510 may be recoupled to the primary reservoir 520 to prevent contaminants from entering or the herbicide 580 from exiting the apparatus 500 (see FIG. 5E). The plant may then begin to siphon or absorb the herbicide 580 at the base 570 of the plant cavity 560 and into the roots of the plant, resulting in the plant wilting and dying (again see FIG. 5E).

It should be appreciated that the embodiments of the present invention are not limited to those specifically described above. For instances, the apparatuses of the present invention may include different structures, features, or characteristics than those described above. Similarly, the methods of the present invention may include different operations, steps, or sequences than those described above. Therefore, it is to be understood that the present invention is not limited to the embodiments described above, but encompasses any and all embodiments within the scope of the following claims.

1. An apparatus, comprising:
a primary reservoir comprising a primary reservoir cavity and an herbicide reception interface, the herbicide reception interface configured to enable at least one herbicide to enter the apparatus;
a primary reservoir cap coupled with the primary reservoir, the primary reservoir cap configured to deter the at least one herbicide from exiting the apparatus via the herbicide reception interface;
a tapered reservoir connected to the primary reservoir, the tapered reservoir comprising a tapered reservoir cavity and an herbicide delivery interface configured to enable the at least one herbicide to exit the apparatus; and
a tapered reservoir cap coupled with the tapered reservoir, the tapered reservoir cap configured to deter the at least one herbicide from exiting the apparatus via the herbicide delivery interface.

2. The apparatus of claim 1, wherein the primary reservoir cap comprises a plant reception interface configured to enable a plant member to enter the apparatus via the primary reservoir cap.

3. The apparatus of claim 1, wherein the primary reservoir and the tapered reservoir comprise a pliable and transparent polymer.

4. The apparatus of claim 1, further comprising:
a stabilization portion connecting the primary reservoir and the tapered reservoir, the stabilization portion configured to stabilize the apparatus when the tapered reservoir is inserted into a plant cavity.

5. The apparatus of claim 1, further comprising:
a primary reservoir coupler configured to couple the primary reservoir cap with the primary reservoir.

6. The apparatus of claim 1, further comprising:
a tapered reservoir coupler configured to couple the tapered reservoir cap with the tapered reservoir.

7. A method, comprising:
removing a primary reservoir cap coupled with a primary reservoir from the primary reservoir, the primary reservoir comprising a primary reservoir cavity and an herbicide reception interface;
introducing at least one herbicide into the primary reservoir cavity via an herbicide reception interface, wherein the primary reservoir is connected to a tapered reservoir comprising a tapered reservoir cavity and an herbicide delivery interface;
coupling the primary reservoir cap with the primary reservoir; and
inserting a plant member into the primary reservoir cavity and the tapered reservoir cavity via the primary reservoir cap.

8. The method of claim 7, wherein the inserting of the plant member via the primary reservoir cap comprises inserting the plant member via a plant reception interface of the primary reservoir cap.

9. The method of claim 7, wherein the coupling of the primary reservoir cap with the primary reservoir comprises engaging a primary reservoir coupler of the primary reservoir with the primary reservoir cap.

10. The method of claim 7, further comprising:
coupling a tapered reservoir cap with the tapered reservoir.

11. A method, comprising:
removing a primary reservoir cap coupled with a primary reservoir, wherein the primary reservoir comprises an herbicide reception interface and a primary reservoir cavity and the primary reservoir is connected to a tapered reservoir comprising a tapered reservoir cavity and an herbicide delivery interface;
removing a tapered reservoir cap coupled with the tapered reservoir;
inserting at least a portion of the tapered reservoir into a plant cavity; and
introducing at least one herbicide into the primary reservoir cavity via the herbicide delivery interface of the primary reservoir.

12. The method of claim 11, further comprising:
coupling the primary reservoir cap with the primary reservoir.

13. The method of claim 11, further comprising:
engaging a stabilization portion connecting the primary reservoir and the tapered reservoir with a surface of a plant member.
